(19) United States
(12) Patent Application Publication
(10) Pub. No.: US 2009/0262838 A1
(43) Pub. Date: Oct. 22, 2009

(54) METHOD AND APPARATUS FOR ENCODING TRANSMISSION DATA BLOCKS FOR ENHANCED SWITCHING PERFORMANCE

(75) Inventors: Ralph Gholmieh, San Diego, CA (US); Tao Tian, San Diego, CA (US); An Mei Chen, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/426,830

(22) Filed: Apr. 20, 2009

Related U.S. Application Data
(60) Provisional application No. 61/046,798, filed on Apr. 21, 2008.
(60) Provisional application No. 61/051,408, filed on May 8, 2008.

(51) Int. Cl. H04N 11/02

(52) U.S. Cl. 375/240.27; 375/E07.279

(57) ABSTRACT

Implementations relate to systems and methods for encoding block data to deliver content to a mobile wireless or other device. Content, such as audio, video or textual content, can be generated for broadcast in source blocks that are decomposed into a set of high priority blocks and a set of low priority blocks. Forward error correction is performed on the set of high priority blocks and set of low priority blocks to generate a set of repair symbols for use in reconstructing aggregate transmission blocks of content. The set of low priority blocks and set of repair symbols for a subsequent period can be shifted or inserted into an aggregate transmission block of a prior period. When a request to change channels is received, the decoding of the high priority block corresponding to the content of the new channel can begin before subsequent aggregate transmission blocks are received.

### CROSS-REFERENCE TO RELATED APPLICATIONS

This application is related and claims priority to U.S. Provisional Application No. 61/046,798 filed Apr. 21, 2008, assigned or under obligation of assignment to the assignee of the present application, entitled “Method and Apparatus for Encoding Transmission Data Blocks for Enhanced Switching Performance,” and to U.S. Provisional Application No. 61/051,048 filed May 8, 2008, assigned or under obligation of assignment to the assignee of the present application, entitled “Transmission of a Flow on Multiple MLC's to Increase Reception Time Diversity,” each of which applications is incorporated herein by reference.

### BACKGROUND

Media streams that are broadcast over digital broadcast networks can be encoded into source, and transmitted over a wireless or other channel to a variety of receiving devices. Typically, the source blocks are encoded jointly using forward error correction coding to form an aggregate transmission block that combines the individual source blocks in a channel. The switching time between channels depends on the amount of data carried by each aggregate transmission block, since receipt of a given block will typically continue until that block is completely received. In the case of real-time applications, data occupying a period T can be grouped into one transmission block, and then broadcast. Typically, the receiver waits until all the sub-blocks within a transmission block are received and decoded, before playing any content within the just-received transmission block. FIG. 1 shows conventional transmission blocks carrying the content of a real-time channel in T milliseconds' worth of data blocks.

In the case when the target receivers of the media transmission have high-capacity batteries, plug-in power, or other abundant sources of energy, and when the transmission medium has low packet error rates, the transmission blocks can be kept small to ensure rapid switching times at the receiver. This is the case, for example, of digital radio (non-satellite), and digital cable. Channel switching time, T, in such cases can be on the order of tens of milliseconds.

When the target receivers have limited sources of energy, and/or when the transmission medium experiences periods of higher packet error loss, the transmission blocks are typically made larger and spread in time, to ensure better channel diversity and to allow the use of longer FEC code blocks. Channel switching time in this case can be on the order of seconds. This is the case, for example, of digital radio over satellite, digital video over satellite, and wireless digital broadcast to untethered devices, such as the MediaFLO™ system developed by Qualcomm Inc. of San Diego, Calif., or others (e.g., Digital Video Broadcasting-Handheld, or DVB-H).

FIG. 2 shows the data block schema in a known MediaFLO™ system. In implementations as shown, data blocks transmitted jointly carry one seconds' worth of data. The channel is partitioned into superframes that are one second long in duration, and which carry one second worth of data each. A superframe can be further divided into four frames each carrying one fourth of the total number of bits in the physical layer. In implementations, a logical channel can be established which combines multiple data channels, such as three. To conserve battery power at the device, the physical layer data for a particular logical channel can be transmitted in four bursts at approximately 250 ms intervals. The physical layer data includes the user data encapsulated in media access control (MAC) packets, as well as parity check packets. A code rate of R (0<R<=1) allows the recovery from an error rate that is as high as (1−R), in these circumstances. To ensure better time diversity, code blocks can be spread over the data carried by the four frames.

FIG. 3 shows a variation of the transmission schema of FIG. 1, but where every two of the transmission blocks shown are concatenated. The benefit of this concatenation is that the blocks in FIG. 2 are transmitted over double the time and carry double the amount of data, on average. This ensures better time diversity and, if desired, FEC coding over longer code blocks. For example, on a MediaFLO™ system, the channel data over the duration of two superframes would be transmitted over the duration of two superframes, and thus the data would be transmitted in eight bursts, instead of four. The coding rate required to sustain a target error probability is reduced when going from the system in FIG. 1 to the one in FIG. 2.

It may be noted, however, that if a user desires to switch channels in the known system shown in FIG. 3, the receiver must wait until a whole transmission block is received, before displaying the data. Partial blocks in such implementations may not contain enough data to start playing media, and in this case, the switching time is increased from 1 second to 2 seconds. Furthermore, on a typical user interface, requests for channel switching take place at random, and thus the user may trigger a channel switch at any arbitrary time within the time a transmission block is being received. This causes an additional switching latency of one half the transmission block duration, on average. Thus, the channel switching time is effectively increased from 1.5 seconds to 3 seconds on average, an amount which may be noticeable by the user. In other words, the length of aggregate transmission blocks can be increased to derive better coding rates, time diversity and throughput, but these results are achieved at the expense of increased channel switching times at the device.

Therefore, a platforms and techniques may be desirable that provide improved forward error protection in media delivery systems without a corresponding increase in the channel switching time.

### SUMMARY

According to the present teachings in one or more aspects, systems and methods for encoding transmission data blocks for enhanced switching performance are provided, in which a forward error correction mechanism operating on block transmission data operates to control how a broadcast stream is encoded and distributed over a set of interleaved blocks. In general implementations of the present teachings, the forward error correction mechanism can divide the encoded data into source transmission blocks covering T milliseconds of the source data, and further divide each such source block into a high priority data sub-block, and a lower priority data sub-block. The forward error correction mechanism can create a repair symbols sub-block from the high priority and low priority sub-blocks. The content of the high priority sub-block can permit the receiver to render a lower quality version of the data carried by the original source block, by itself. In implementations, the high priority data sub-block can be transmitted in the last transmission block carrying data for the original source block. In implementations, the forward error correction mechanism can be implemented at the physical layer, at the transport layer, at the application layer, and/or other layers of the transmission media and associated resources.

Systems and methods according to the present teachings provide improved coding in one regard by spreading or shifting lower priority data sub-blocks, and repair symbols sub-blocks, into previous transmission blocks in a transmission stream. The stream of aggregate transmission blocks can be buffered or stored at the receiving device, so that multiple sets of complete transmission blocks are available to the receiver/decoder. The presence of lower priority sub-blocks and repair symbols sub-blocks in preceding transmission blocks, frames or windows can permit the decoding of a high priority data sub-block in a window to begin immediately or with minimum possible delay, since the necessary repair symbols and/or low-priority sub-blocks for the high priority block are already in possession of the decoder. In implementations, the transmission streams of the transmission blocks can be channelized into multiple logical or physical channels, for instance to achieve improved time diversity. The channel switching time can remain the same compared to non-concatenated schemes, since the embedded high priority packets again allow a receiver to immediately start rendering data by decoding the last transmission block carrying the high priority data block of a source block.

### DESCRIPTION OF THE DRAWINGS

The accompanying drawings, which are incorporated in and constitute a part of this specification, illustrate aspects of the present teachings and together with the description, serve to explain principles of the present teachings. In the figures:

FIG. 1 shows the data block structure of the content of a real-time channel in a period of T milliseconds' worth of data blocks, according to implementations of the present teachings;

FIG. 2 shows the data block structure of the content of a real-time channel in 2T milliseconds' worth of data blocks, according to implementations;

FIG. 3 shows the data block structure of the content of a real-time channel in a MediaFLO™ system in blocks carrying 1 second worth of data, according to implementations;

FIG. 4 shows a timing diagram that illustrates the division of the transmission blocks into high priority, low priority, and repair symbols sub-blocks, according to various aspects of the present teachings;

FIG. 5 shows a timing diagram that illustrates the moving or shifting of low priority data blocks and repair symbols sub-blocks into a previous transmission block, according to various aspects of the present teachings;

FIG. 6 shows a timing diagram that illustrates the moving or shifting of low priority data blocks and repair symbols sub-blocks into an earlier transmission block, according to various further aspects of the present teachings;

FIG. 7 shows a timing diagram that illustrates a case where the source block and the high-priority block are the same, according to various aspects of the present teachings;

FIG. 8 shows a timing diagram that a case where the source block and the high-priority block are the same, and when the repair symbols are transmitted in the previous transmission block, according to various aspects of the present teachings;

FIG. 9 shows a timing diagram that illustrates a case where the source block and the high-priority block are the same, and when the repair symbols are transmitted in a preceding transmission block, according to various aspects of the present teachings;

FIG. 10 shows a timing diagram that illustrates a case where multiple channels are used to transmit transmission blocks, according to various aspects of the present teachings;

FIG. 11 shows a network that comprises a content delivery system consistent with coding techniques described herein, according to various aspects of the present teachings;

FIG. 12 shows an embodiment of a content provider suitable for use in a content delivery system consistent with coding techniques described herein, according to various aspects of the present teachings; and

FIG. 13 shows an embodiment of a content server suitable for use in a content delivery system consistent with coding techniques described herein, according to various aspects of the present teachings.

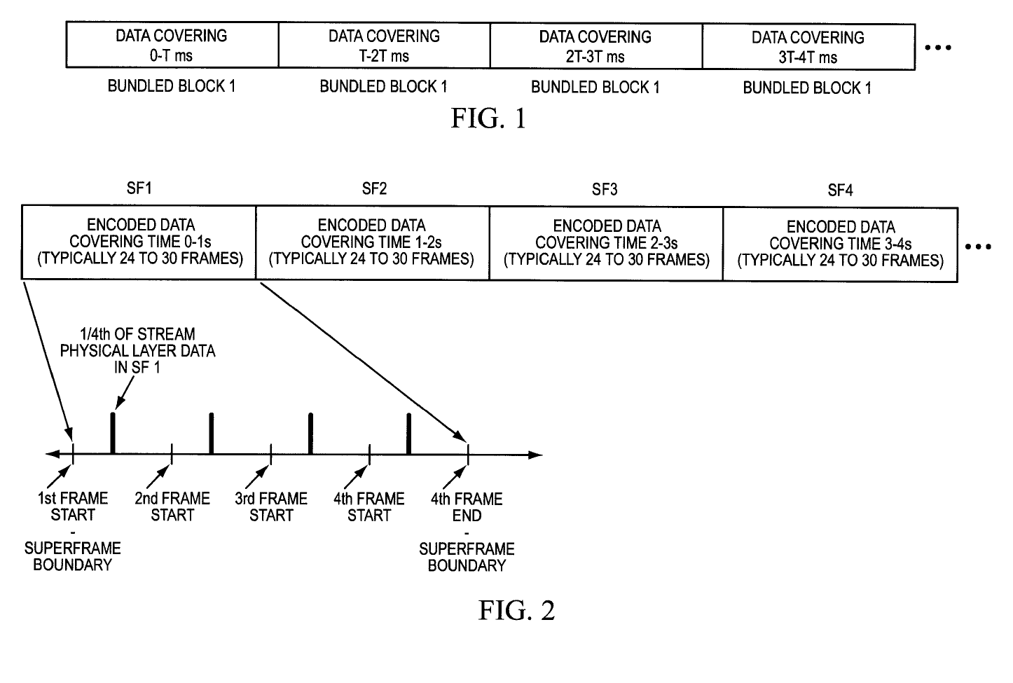

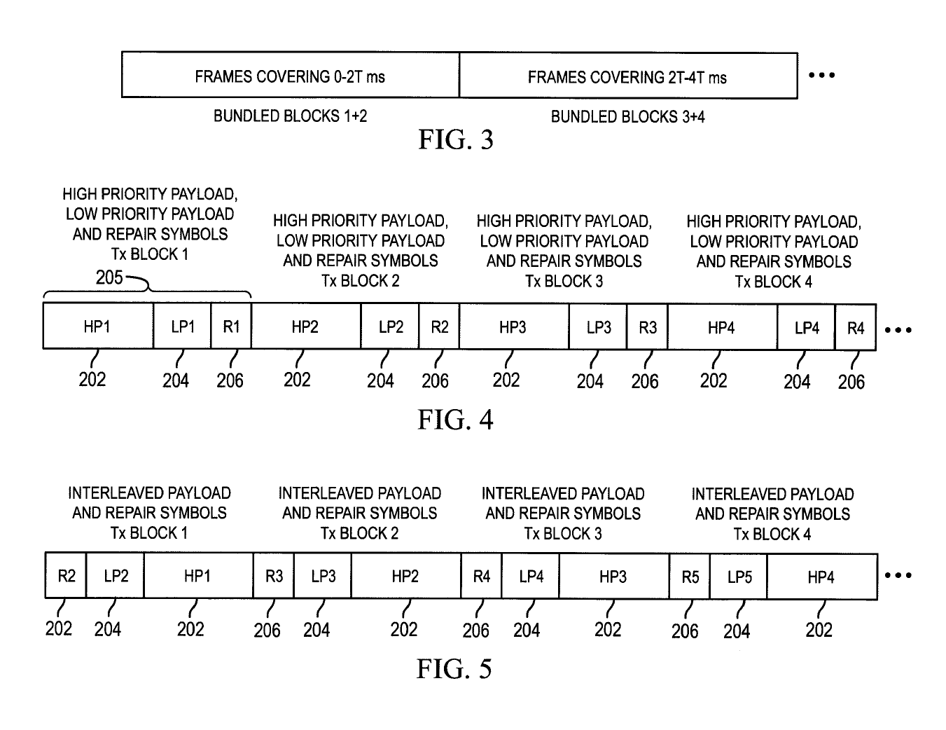

### DETAILED DESCRIPTION

Aspects of the present teachings relate to systems and methods for encoding transmission data blocks for enhanced switching performance. More particularly, in various aspects, forward error correction (FEC) and other coding platforms and techniques described herein can be used for improving the decoding performance in a broadcast network, without sacrificing channel switching latency compared to known schemes. The present teachings can provide an improvement, in one regard, in forward error correction mechanisms over channels carrying real-time data and using relatively large frames. An example of this type of environment is the aforementioned MediaFLO™ platform, where real-time video, audio, or other data is broadcast over the air, and the superframe duration can be set to one second or other amounts. In implementations, a receiver must wait until the end of the current physical layer frame (e.g. the superframe in MediaFLO™ systems) before displaying or rendering the transmitted data. Systems and methods according to the present teachings allow the use of forward error correction in such a way that the switching time is minimized while the time diversity over the transmitted data is increased, allowing better coverage and/or better signal quality at the receiver of the signal.

In further aspects, methods of using any forward error correction mechanism over block transmission mediums are provided that operate to control how a broadcast stream is encoded and distributed over transmission blocks. In various implementations, the forward error correction mechanism can be implemented at the physical layer, at the transport layer, at the application layer, and/or at other layers in the transmission media and associated resources.

According to general implementations of the present teachings, and as shown for example in FIG. 4, the forward error correction mechanism can divide the encoded data into source blocks covering a period of T milliseconds of the source stream data or other content, and further divide or decompose each such source block into a set of high priority data sub-blocks 202, and a set of low priority data sub-blocks 204. The parameter “T” as used at times herein denotes the duration of the transmission blocks at the physical layer of the transmission medium. For example, T can be 1 second (1000 milliseconds) in various implementations of a MediaFLO™ broadcast system. The forward error correction mechanism can also create a set of repair symbols sub-blocks 206 from the set of high priority sub-blocks 202 and set of low priority sub-blocks 204.

Forward error correction can be encoded using techniques known to persons skilled in the art, wherein, generally, redundant data is inserted into the message payload to permit the detection and/or correction of errors without re-transmission from the transmission source. According to implementations, forward error correction algorithms can include, for instance, soft Viterbi codes or other FEC techniques or schemes. For further example, in implementations, the forward error correction algorithms employed to transmit the transmission blocks can be or include the DF Raptor™ FEC encoder provided by Digital Fountain, a related entity of Qualcomm Inc.

Without loss in generality, FIG. 4 illustrates an exemplary possible decomposition of a complete transmission block into a set of high priority sub-blocks 202, a set of low priority sub-blocks 204, and a set of repair symbols sub-blocks 206 as shown, according to implementations of the present teachings in a general regard. In FIG. 4, the source block and its encoded repair block is illustrated as being encoded within the same transmission block. According to aspects of the present teachings in one regard, the content of a high priority sub-block can be constituted to allow the receiver to render a lower quality or reduced-resolution version of the data carried by the original source block, by itself. For example, each block in set of high-priority sub-blocks 202 can contain sufficient pixel data to render a reduced-resolution version of a video frame, or other content having sufficient resolution to be useful or viewable by the user of the device.

According to various implementations of the present teachings in further regards, and as variously illustrated in FIGS. 5-10, the three constituent sub-blocks (high priority, low priority, and repair) can be distributed or extended over multiple transmission blocks. In an aspect, the lower priority data sub-blocks and repair symbols can be distributed over or shifted into previous transmission blocks. The insertion of a set of low priority sub-blocks 204 and set of repair symbols sub-blocks 206 earlier in the transmission stream, to be part of the transmission block occupied by an earlier high priority sub-block, can permit the immediate decoding of downstream high-priority sub-block in the stream. This can occur in one regards since necessary decoding information to decode a current high priority sub-block is already available to the decoder of the recipient device. The high priority data sub-block can be transmitted in the last transmission block or slot carrying data for the original source block. In implementations, the low priority data can be chosen such that a receiver can recover all the data encoded in the original source block, if the low and high priority data is recovered without error.

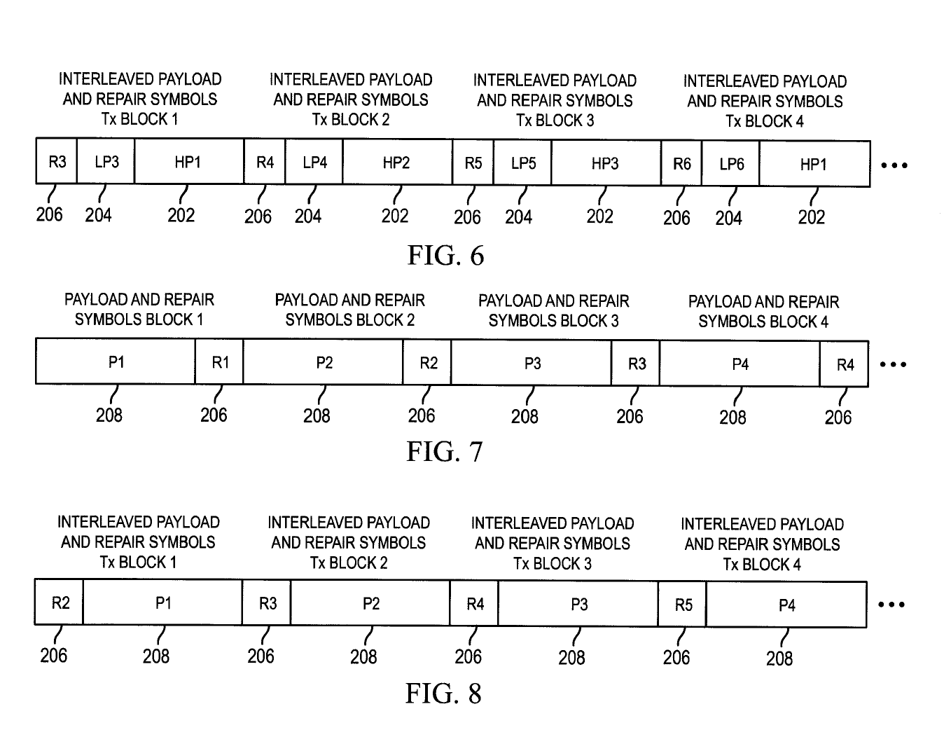

In various aspects of the present teachings, the number of blocks or slots by which the set of low priority sub-blocks 204 and set of repair blocks 206 can be shifted can vary, for example to achieve greater or lesser time diversity or separation between different frames. As for example illustrated in FIG. 5, in one aspect of the present teachings, the set of low priority sub-blocks 204 and set of repair symbols 206 can be transmitted in the frame directly preceding the frame carrying current high priority sub-block. This aspect is for example illustrated in FIG. 5. As for example illustrated in FIG. 6, in other aspects of the present teachings, the set of low priority sub-blocks 204 and set of repair symbols 206 can be transmitted in a frame preceding the frame carrying the high priority sub-block by two frames. Other numbers of frame shifts can be used, for example, three or more frames. According to various implementations in further regards, it may be noted that one or more blocks of any one of the set of high priority sub-blocks 202, set of low priority sub-blocks 204, and set of repair blocks 206 can be spread or distributed into multiple transmission blocks. Such implementations can, in one regard, increase the time diversity of the transmitted signals, although that increased time diversity may in cases be achieved at the expense of increased switching times, particularly when one or more blocks of the set of high priority sub-blocks 202 are distributed across multiple transmission blocks.

The channel switching time in implementations of the present teachings can remain the same as non-concatenated transmission schemes, since the set of high priority sub-blocks 202 allow a receiver to immediately start rendering data by decoding the last received transmission block carrying the high priority data block of a source block. The set of low priority sub-blocks 204 and set of repair sub-blocks 206 carried in the received overall transmission block can be buffered for use when decoding the corresponding later high priority sub-block. Thus, the received quality of the stream will rapidly improve to the maximum level allowed by the forward error correction mechanism employed.

In aspects of the present teachings, the repair symbols can be the same as those transmitted, in the case where there is no distinction between high and low priority blocks, which can be combined into one block. In such cases, both high priority and low priority packets can jointly encoded using a code of rate R. In further aspects of the present teachings, the repair symbols can be configured to protect the high and low priority sub-blocks using different degrees, rates, or priorities. For example, repair packets for the high priority sub-block can be generated using a code rate R1, while repair packets for the low priority sub-block can be generated using a code rate R2, where R2<R1. In another aspect, an appropriate forward error correction code can be used over the combined high priority and low priority sub-blocks, such that high priority packets have higher error protection and/or higher priority than lower priority packets. In still further aspects, blocks within the set of low priority sub-blocks 204 may be dropped in case of channel congestion. This can for instance be taken into account when scheduling the transmission blocks into a frame.

According to aspects of the present teachings in yet further regards, the source data can be divided into multiple priority levels, instead of two levels identified as high-priority and low-priority levels. In implementations according to these aspects, the lowest priority sub-block can be scheduled or inserted in the earliest transmission block carrying data for the source block of interest. In implementations according to these aspects, the highest priority sub-block can be scheduled or inserted in the last transmission block carrying data for the lowest priority level. The different priority levels can in one regard provide different quality levels of the encoded source block. According to aspects of the present teachings in still further regards, the low priority sub-blocks can themselves be further divided into higher priority and lower priority packets or blocks. In aspects, the low priority sub-blocks can be subdivided into two, three or more blocks. In implementations, each of the various low priority sub-blocks can be transmitted in a different transmission block. In multi-level low priority block implementations, the greater the number of the low priority sub-blocks the decoder receives, the better in one regard the quality of the content rendered on the recipient device.

According to various implementations, the streamed data can comprise H.264 video data. In this case, video frames can be encoded and broadcast over the broadcast/multicast streams. The high priority packets in this case can be those carrying I and P frames, while the lower priority packets can be those carrying B frames, as understood by persons skilled in the art. In implementations configured to transmit H.264 video, the high priority packets can be a fully decodable subset of the I and P frames, while the low priority packets will be constituted of the remaining encoded frames. In implementations, the forward error correction of the H.264 blocks can be done at the application layer. In implementations, the forward error correction of the H.264 blocks can be done at the physical layer, as long as the application layer packets are tagged with a priority level as they are passed to the lower transport and MAC layers.

In implementations, if the division of the data carried by a source block into high priority and low priority sub-blocks is not possible on the type of data carried by the stream, or if this division is not possible at the layer where the forward error correction is implemented, or if the operator so desires, then all the coded data in a block can be identified or considered as high priority or one combined block 208. This type of implementation is for example illustrated in FIG. 7. In implementations, the low priority data can be chosen to allow a receiver to recover all the data encoded in the original source block, if both the low and high priority data is received without error.

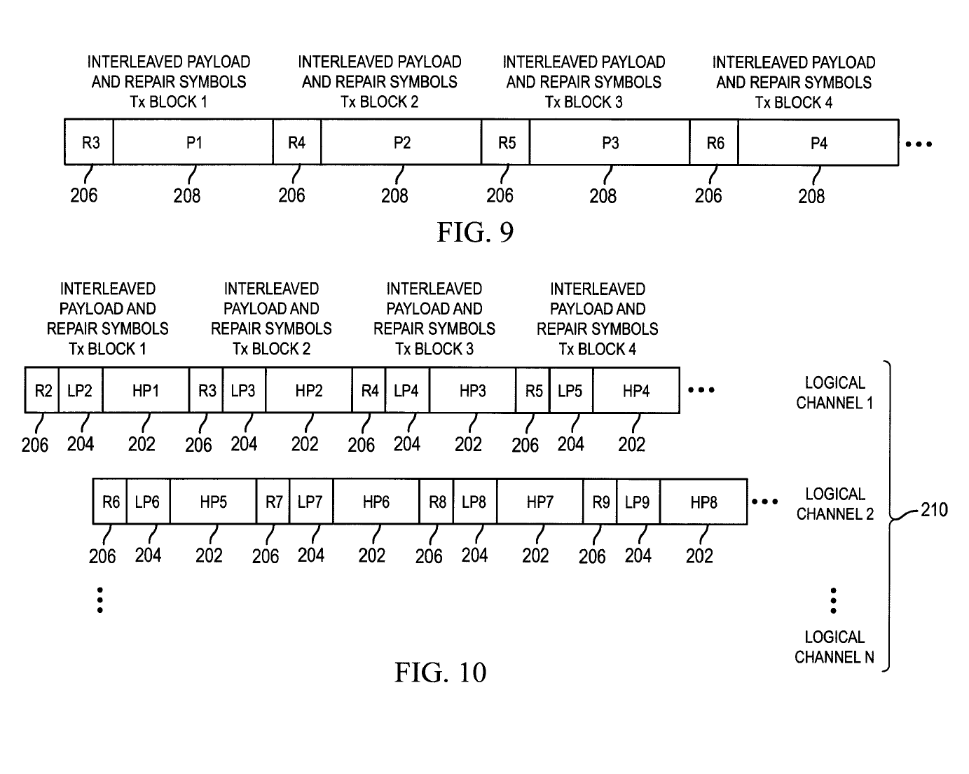

In implementations of the present teachings, the repair symbols can be transmitted in the frame preceding the frame carrying the combined block 208. This aspect is for example illustrated in FIG. 8. In further implementations of the present teachings, the set of repair symbols 206 can be transmitted in the frame preceding the frame carrying the combined block 208 by two frames. This is for example illustrated in FIG. 9. Other numbers of frame shifts can be used.

According to various aspects of the present teachings, the content delivery system can be or include a wireless content delivery system, such as the MediaFLO™ system developed by the Qualcomm Inc. of San Diego, Calif. In aspects, the content delivery system can be or include a content delivery platform based on wired or optical connections, in addition to or instead of a wireless interface. In general, the content delivered by the content delivery system can include video media, such as video clips encoded in the Real™ format, the Motion Pictures Group (.mpg) format, the Windows Media format by Microsoft Corp., or other video codec or format. The content can include audio media, such as music tracks or broadcast recordings encoded in Motion Pictures Expert Group (MPEG)-1 Audio Layer 3 (MP3) format, Microsoft Corp. “.wav” format, RealAudio™ format, or other audio codec or format. The content can further include textual content, such as streaming stock quotes, weather reports, or other data.

According to aspects, in addition to single-channel transmission implementations shown for instance in FIGS. 5-10, in implementations the transmission of set of high priority sub-blocks 202, set of low priority sub blocks 204, set of repair symbols 206, and/or other data can be transmitted via a set of set of logical channels 210. In implementations, set of logical channels 210 can comprise a set of multicast logical channels (MLCs) such as those employed in the aforementioned MediaFLO™ system. The use of a set of logical channels 210 can increase the time diversity of data received within a superframe. In implementations, data from one flow can be distributed over multiple logical channels in set of logical channels 210. In this case a slot allocation algorithm at the transmission headend can be made aware of the contents of the logical channels. In implementations, time diversity or time separation between the slots carrying the logical channels can be maximized by that assignment algorithm. According to implementations in one regard, the receiving device can wake up to monitor set of logical channels 210, more frequently than in single-channel implementations. In implementations, different flows can be distributed over multiple different logical channels, or using other algorithms or criteria. For instance, in implementations, the data transmitted over one logical channel can be scheduled in multiple blocks of slots. Block locations can be signaled in the overhead information signals (OIS), or other signaling channels. It may be noted that while FIG. 10 illustrates an implementation where multiple logical channels are used, in implementations, multiple physical channels and/or a mix of logical and physical channels can be used for delivery of the transmission stream.

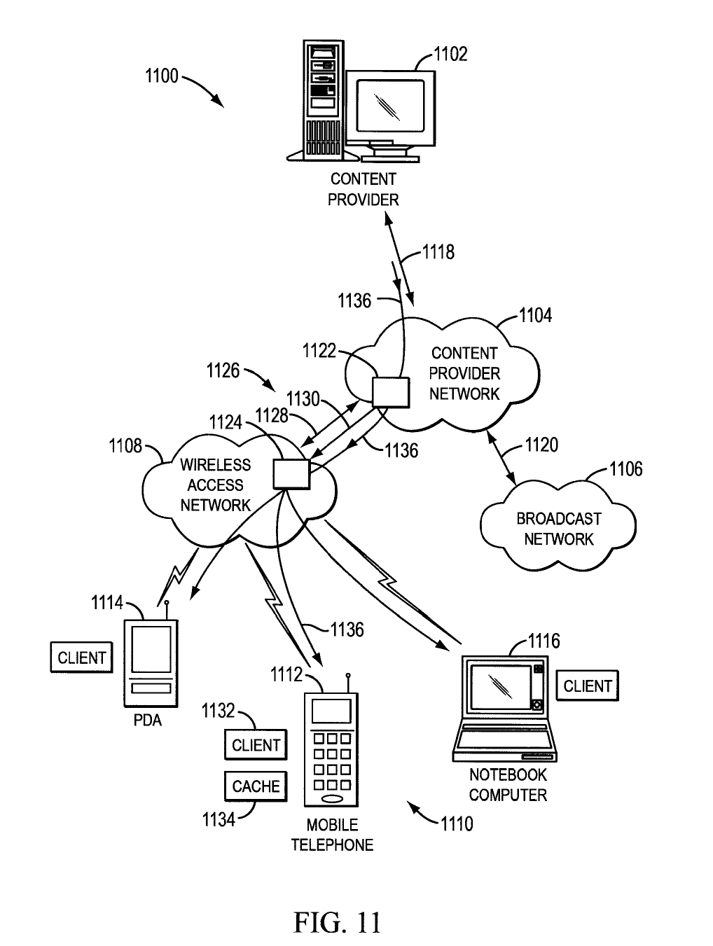

FIGS. 11-13 illustrate various network environments in which systems and methods for encoding transmission data blocks for enhanced switching performance can be implemented, consistent with aspects of the present teachings. FIG. 11 shows one implementation of a communication network 1100 that comprises one implementation of a transport system that operates to create and transport multimedia content flows across data networks. For example, the transport system is suitable for use in transporting content clips from a content provider network to a wireless access network for broadcast distribution.

The network 1100 comprises a content provider (CP) 1102, a content provider network 1104, a broadcast network 1106 which can be or include a wireless network optimized for broadcast delivery, and a wireless access network 1108. The network 1100 also includes devices 1110 that comprise a mobile telephone 1112, a personal digital assistance (PDA) 1114, and a notebook computer 1116. The devices 1110 illustrate just some of the devices that are suitable for use in one or more aspects of the transport system. It should be noted that although three devices are shown in FIG. 10, virtually any number or types of devices are suitable for use in the transport system.

The content provider 1102 operates to provide content for distribution to users in the network 1100. The content comprises video, audio, multimedia content, clips, real-time and non real-time content, scripts, programs, data or any other type of suitable content. The content provider 1102 provides the content to the content provider network 1104 for distribution. For example the content provider 1102 communicates with the content provider network 1104 via the communication link 1118, which comprises any suitable type of wired and/or wireless communication link.

The content provider network 1104 comprises any combination of wired and wireless networks that operate to distribute content for delivery to users. The content provider network 1104 communicates with the broadcast network 1106 via the link 1120. The link 1120 comprises any suitable type of wired and/or wireless communication link. The broadcast network 1106 comprises any combination of wired and wireless networks that are designed to broadcast high quality content. For example, broadcast network 1106 may be a specialized proprietary network that has been optimized to deliver high quality content to selected devices over a plurality of optimized communication channels.

In one or more implementations, the transport system operates to deliver content from the content provider 1102 for distribution to a content server (CS) 1122 at the content provider network 1104 that operates to communicate with a broadcast base station (BBS) 1124 at the wireless access network. The CS 1122 and the BBS 1124 communicate using one or more aspects of a transport interface 1126 that allows the content provider network 1104 to deliver content in the form of content flows to the wireless access network 1108 for broadcast/multicast to the devices 1110. The transport interface 1126 comprises a control interface 1128 and a bearer channel 1130. The control interface 1128 operates to allow the CS 1122 to add, change, cancel, or otherwise modify contents flows that flow from the content provider network 1104 to the wireless access network 1108. The bearer channel 1130 operates to transport the content flows from the content provider network 1104 to the wireless access network 1108.

In one implementation, the CS 1122 uses the transport interface 1126 to schedule a content flow to be transmitted to the BBS 1124 for broadcast/multicast over the wireless access network 1108. For example, the content flow may comprise a non real-time content clip that was provided by the content provider 1102 for distribution using the content provider network 1104. In one implementation, the CS 1122 operates to negotiate with the BBS 1124 to determine one or more parameters associated with the content clip. Once the BBS 1124 receives the content clip, it broadcasts/multicasts the content clip over the wireless access network 1108 for reception by one or more of the devices 1110. Any of the devices 1110 may be authorized to receive the content clip and cache it for later viewing by the device user.

For example the device 1110 comprises a client program 1132 that operates to provide a program guide that displays a listing of content that is scheduled for broadcast over the wireless access network 1108. The device user may then select to receive any particular content for rendering in real-time or to be stored in a cache 1134 for later viewing. For example the content clip may be scheduled for broadcast during the evening hours, and the device 1112 operates to receive the broadcast and cache the content clip in the cache 1134 so that the device user may view the clip the next day. Typically, the content is broadcast as part of a subscription service and the receiving device may need to provide a key or otherwise authenticate itself to receive the broadcast.

In one or more implementations, the transport system allows the CS 1122 to receive program-guide records, program contents, and other related information from content provider 1102. The CS 1122 updates and/or creates content for delivery to devices 1110.

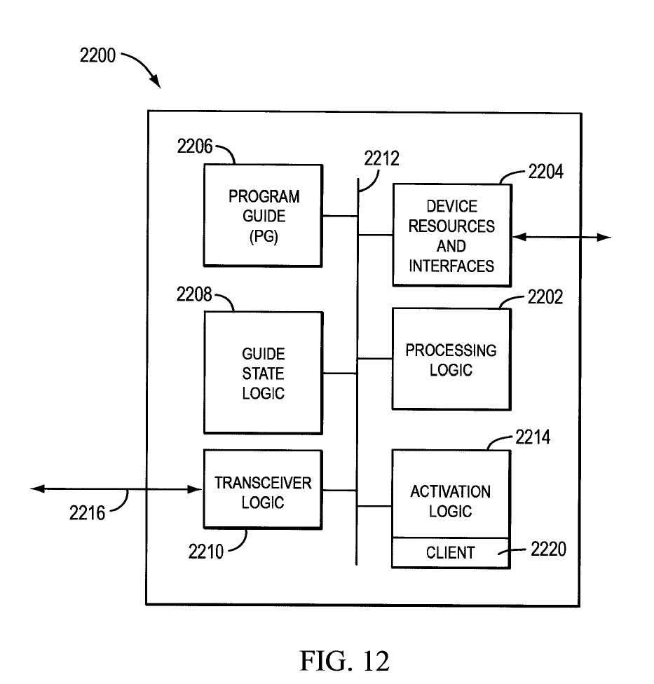

FIG. 12 shows one implementation of a content provider server 2200 suitable for use in one implementation of the content delivery system. For example, the server 2200 may be used as the server 1102 in FIG. 11. The server 2200 comprises processing logic 2202, resources and interfaces 2204, and transceiver logic 2210, all coupled to an internal data bus 2212. The server 2200 also comprises activation logic 2214, PG logic 2206, and PG record logic 2208, which are also coupled to the data bus 2212.

In one or more implementations, the processing logic 2202 comprises a CPU, processor, gate array, hardware logic, memory elements, virtual machine, software, and/or any combination of hardware and software. Thus, the processing logic 2202 generally comprises logic to execute machine-readable instructions and to control one or more other functional elements of the server 2200 via the internal data bus 2212.

The resources and interfaces 2204 comprise hardware and/or software that allow the server 2200 to communicate with internal and external systems. For example, the internal systems may include mass storage systems, memory, display driver, modem, or other internal device resources. The external systems may include user interface devices, printers, disk drives, or other local devices or systems.

The transceiver logic 2210 comprises hardware logic and/or software that operate to allow the server 2200 to transmit and receive data and/or other information with remote devices or systems using communication channel 2216. For example, in one implementation, the communication channel 2216 comprises any suitable type of communication link to allow the server 2200 to communicate with a data network.

The activation logic 2214 comprises a CPU, processor, gate array, hardware logic, memory elements, virtual machine, software, and/or any combination of hardware and software. The activation logic 2214 operates to activate a CS and/or a device to allow the CS and/or the device to select and receive content and/or services described in the PG 2206. In one implementation, the activation logic 2214 transmits a client program 2220 to the CS and/or the device during the activation process. The client program 2220 runs on the CS and/or the device to receive the PG 2206 and display information about available content or services to the device user. Thus, the activation logic 2214 operates to authenticate a CS and/or a device, download the client 2220, and download the PG 2206 for rendering on the device by the client 2220.

The PG 2206 comprises information in any suitable format that describes content and/or services that are available for devices to receive. For example, the PG 2206 may be stored in a local memory of the server 2200 and may comprise information such as content or service identifiers, scheduling information, pricing, and/or any other type of relevant information. In one implementation, the PG 2206 comprises one or more identifiable sections that are updated by the processing logic 2202 as changes are made to the available content or services.

The PG record 2208 comprises hardware and/or software that operate to generate notification messages that identify and/or describe changes to the PG 2206. For example, when the processing logic 2202 updates the PG 2206, the PG records logic 2208 is notified about the changes. The PG records logic 2208 then generates one or more notification messages that are transmitted to CSs, which may have been activated with the server 2200, so that these CSs are promptly notified about the changes to the PG 2206.

In one implementation, as part of the content delivery notification message, a broadcast indicator is provided that indicates when a section of the PG identified in the message will be broadcast. For example, in one implementation, the broadcast indicator comprises one bit to indicate that the section will be broadcast and a time indicator that indicates when the broadcast will occur. Thus, the CSs and/or the devices wishing to update their local copy of the PG records can listen for the broadcast at the designated time to receive the updated section of the PG records.

In one implementation, the content delivery notification system comprises program instructions stored on a computer-readable media, which when executed by a processor, for instance, the processing logic 2202, provides the functions of the server 2200 described herein. For example, the program instructions may be loaded into the server 2200 from a computer-readable media, such as a floppy disk, CDROM, memory card, FLASH memory device, RAM, ROM, or any other type of memory device or computer-readable media that interfaces to the server 2200 through the resources 2204. In another implementation, the instructions may be downloaded into the server 2200 from an external device or network resource that interfaces to the server 2200 through the transceiver logic 2210. The program instructions, when executed by the processing logic 2202, provide one or more aspects of a guide state notification system as described herein.

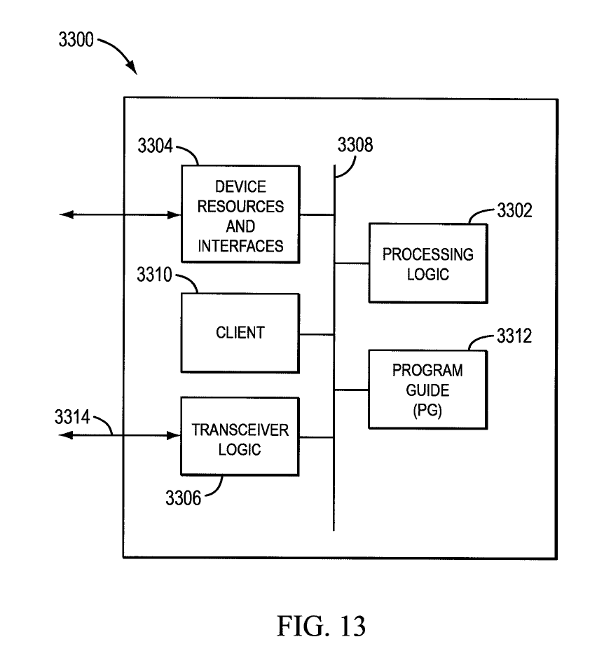

FIG. 13 shows one implementation of a content server (CS) or device 3300 suitable for use in one implementation of a content delivery system. For example, CS 3300 may be the CS 1122 or the device 1110 shown in FIG. 11. The CS 3300 comprises processing logic 3302, resources and interfaces 3304, and transceiver logic 3306, all coupled to a data bus 3308. The CS 3300 also comprises a client 3310, and a PG logic 3312, which are also coupled to the data bus 3308.

In one or more implementations, the processing logic 3302 comprises a CPU, processor, gate array, hardware logic, memory elements, virtual machine, software, and/or any combination of hardware and software. Thus, the processing logic 3302 generally comprises logic configured to execute machine-readable instructions and to control one or more other functional elements of the CS 3300 via the internal data bus 3308.

The resources and interfaces 3304 comprise hardware and/or software that allow the CS 3300 to communicate with internal and external systems. For example, internal systems may include mass storage systems, memory, display driver, modem, or other internal device resources. The external systems may include user interface devices, printers, disk drives, or other local devices or systems.

The transceiver logic 3306 comprises hardware and/or software that operate to allow the CS 3300 to transmit and receive data and/or other information with external devices or systems through communication channel 3314. For example the communication channel 3314 may comprise a network communication link, a wireless communication link, or any other type of communication link.

During operation, the CS and/or the device 3300 is activated so that it may receive available content or services over a data network. For example, in one implementation, the CS and/or the device 3300 identifies itself to a content provider server during an activation process. As part of the activation process, the CS and/or the device 3300 receives and stores PG records by PG logic 3312. The PG 3312 contains information that identifies content or services available for the CS 3300 to receive. The client 3310 operates to render information in the PG logic 3312 on the CS and/or the device 3300 using the resources and interfaces 3304. For example, the client 3310 renders information in the PG logic 3312 on a display screen that is part of the device. The client 3310 also receives user input through the resources and interfaces so that a device user may select content or services.

In one implementation, the CS 3300 receives notification messages through the transceiver logic 3306. For example, the messages may be broadcast or unicast to the CS 3300 and received by the transceiver logic 3306. The PG notification messages identify updates to the PG records at the PG logic 3312. In one implementation, the client 3310 processes the PG notification messages to determine whether the local copy at the PG logic 3312 needs to be updated. For example, in one implementation, the notification messages include a section identifier, start time, end time, and version number. The CS 3300 operates to compare the information in the PG notification messages to locally stored information at the existing PG logic 3312. If the CS 3300 determines from the PG notification messages that one or more sections of the local copy at the PG logic 3312 needs to be updated, the CS 3300 operates to receive the updated sections of the PG in one of several ways. For example, the updated sections of the PG may be broadcasted at a time indicated in the PG notification messages, so that the transceiver logic 3306 may receive the broadcasts and pass the updated sections to the CS 3300, which in turn updates the local copy at the PG logic 3312.

In another implementation, the CS 3300 determines which sections of the PG need to be updated based on the received PG update notification messages, and transmits a request to a CP server to obtain the desired updated sections of the PG. For example, the request may be formatted using any suitable format and comprise information such as a requesting CS identifier, section identifier, version number, and/or any other suitable information.

In one implementation, the CS 3300 performs one or more of the following functions in one or more aspects of a PG notification system. It should be noted that the following functions might be changed, rearranged, modified, added to, deleted, or otherwise adjusted within the scope of various implementations.
1. The CS is activated for operation with a content provider system to receive content or services. As part of the activation process, a client and PG are transmitted to the CS.
2. One or more PG notification messages are received by the CS and used to determine if one or more sections of the locally stored PG need to be updated.
3. In one implementation, if the CS determines that one or more sections of the locally stored PG need to be updated, the CS listens to a broadcast from the distribution system to obtain the updated sections of the PG that it needs to update its local copy.
4. In another implementation, the CS transmits one or more request messages to the CP to obtain the updated sections of the PG it needs.
5. In response to the request, the CP transmits the updated sections of the PG to the CS.
6. The CS uses the received updated sections of the PG to update its local copy of the PG.

In one implementation, the content delivery system comprises program instructions stored on a computer-readable media, which when executed by a processor, such as the processing logic 3302, provides the functions of the content delivery notification system as described herein. For example, instructions may be loaded into the CS 3300 from a computer-readable media, such as a floppy disk, CDROM, memory card, FLASH memory device, RAM, ROM, or any other type of memory device or computer-readable media that interfaces to the CS 3300 through the resources and interfaces 3304. In another implementation, the instructions may be downloaded into the CS 3300 from a network resource that interfaces to the CS 3300 through the transceiver logic 3306. The instructions, when executed by the processing logic 3302, provide one or more aspects of a content delivery system as described herein. It should be noted that the CS 3300 represents just one implementation and that other implementations are possible within the scope of various implementations.

The foregoing description is illustrative, and variations in configuration and implementation may occur to persons skilled in the art. For instance, the various illustrative logics, logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In one or more exemplary implementations, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The steps of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

For further example, while implementations have been described in which an aggregate transmission block consists of a high-priority block (or sub-block), a low-priority block (or sub-block), and a repair symbols block, in implementations other types or numbers of data blocks, fields or schema can be used. For yet further example, while implementations have been described in which the low-priority blocks and repair symbols blocks for a given frame are shifted together, in implementations low-priority blocks and repair symbols blocks for a source transmission block or frame can be inserted in different block periods, for example interleaved in consecutive periods, or distributed or combined in other patterns. Other resources described as singular or integrated can in implementations be plural or distributed, and resources described as multiple or distributed can in implementations be combined. The scope of the present teachings is accordingly intended to be limited only by the following claims.

What is claimed is:

1. A method of encoding data, comprising:
accessing a set of source blocks representing content to deliver to a device;
decomposing the set of source blocks into at least a set of high priority blocks and a set of low priority blocks;
performing forward error correction encoding on the set of high priority blocks and the set of low priority blocks to generate a set of repair symbols; and
combining the set of high priority blocks for a first time period with the set of low priority blocks and the set of repair symbols for at least one other time period to generate an aggregate transmission block for transmission to the device.

2. The method of claim 1, wherein the set of high priority blocks for the first time period are configured to be decoded by the device before receipt of a next aggregate transmission block in the device.

3. The method of claim 1, wherein the at least one other time period comprises at least one time period later than the first time period.

4. The method of claim 1, wherein the content comprises at least one of video media, audio media, or textual media.

5. The method of claim 1, wherein the set of repair symbols encode the set of high priority blocks and the set of low priority blocks with unequal priority.

6. The method of claim 1, further comprising receiving a selection from the user of the device to change a content channel, and initiating the decoding of at least the set of high priority blocks of an aggregate transmission block in a current time period based on the user selection.

7. The method of claim 1, wherein the transmission to the device is via a set of multiple channels creating time diversity for at least one of the set of high priority blocks, set of low priority blocks, and set of repair symbols.

8. The method of claim 1, wherein the set of low priority blocks is divided into multiple sets of lower-level priority blocks, wherein each set of the multiple sets of lower-level priority blocks are transmitted in a different aggregate transmission block.

9. The method of claim 1, wherein at least one block of the set of high priority sub-blocks, or at least one block of the set of low priority sub-blocks, or at least one block of the set of repair symbols are distributed over multiple aggregate transmission blocks.

10. A system for encoding data, comprising:
a first interface to a content source, the content source providing access to a set of source blocks representing content to deliver to a device; and
a processor, communicating with the first interface, the processor being configured to
decompose the set of source blocks into a set of high priority blocks and a set of low priority blocks,
perform forward error correction encoding on the set of high priority blocks and the set of low priority blocks to generate a set of repair symbols, and
combine the set of high priority blocks for a first time period with the set of low priority blocks and the set of repair symbols for at least one other time period to generate an aggregate transmission block for transmission to the device.

11. The system of claim 10, wherein the set of high priority blocks for the first time period are configured to be decoded by the device before receipt of a next aggregate transmission block in the device.

12. The system of claim 10, wherein the at least one other time period comprises at least one time period later than the first time period.

13. The system of claim 10, wherein the content comprises at least one of video media, audio media, or textual media.

14. The system of claim 10, wherein the set of repair symbols encode the set of high priority blocks and the set of low priority blocks with unequal priority.

15. The system of claim 10, wherein the device is configured to receive a selection from the user of the device to change a content channel, and to initiate the decoding of at least the set of high priority blocks of an aggregate transmission block in a current time period based on the user selection.

16. The system of claim 10, wherein the transmission to the device is via a set of multiple channels creating time diversity for at least one of the set of high priority blocks, set of low priority blocks, and set of repair symbols.

17. A system for encoding data, comprising:
first interface means for interfacing to a content source, the content source providing access to a set of source blocks representing content to deliver to a device; and
means for processing, communicating with the first interface means, the means for processing being configured to
decompose the set of source blocks into a set of high priority blocks and a set of low priority blocks,
perform forward error correction encoding on the set of high priority blocks and the set of low priority blocks to generate a set of repair symbols, and
combine the set of high priority blocks for a first time period with the set of low priority blocks and the set of repair symbols for at least one other time period to generate an aggregate transmission block for transmission to the device.

18. The system of claim 17, wherein the set of high priority blocks for the first time period are configured to be decoded by the device before receipt of a next aggregate transmission block in the device.

19. The system of claim 17, wherein the at least one other time period comprises at least one time period later than the first time period.

20. The system of claim 17, wherein the content comprises at least one of video media, audio media, or textual media.

21. The system of claim 17, wherein the set of repair symbols encode the set of high priority blocks and the set of low priority blocks with unequal priority.

22. The system of claim 17, wherein the device is configured to receive a selection from the user of the device to change a content channel, and to initiate the decoding of at least the set of high priority blocks of an aggregate transmission block in a current time period based on the user selection.

23. The system of claim 17, wherein the transmission to the device is via a set of multiple channels creating time diversity for at least one of the set of high priority blocks, set of low priority blocks, and set of repair symbols.

24. A computer program product, comprising:
computer-readable medium comprising:
at least one instruction for causing a computer to access a set of source blocks representing content to deliver to a device;
at least one instruction for causing a computer to decompose the set of source blocks into a set of high priority blocks and a set of low priority blocks;
at least one instruction for causing a computer to perform forward error correction encoding on the set of high priority blocks and the set of low priority blocks to generate a set of repair symbols; and
at least one instruction for causing a computer to combine the set of high priority blocks for a first time period with the set of low priority blocks and the set of repair symbols for at least one other time period to generate an aggregate transmission block for transmission to the device.

25. The computer program product of claim 24, wherein the set of high priority blocks for the first time period are configured to be decoded by the device before receipt of a next aggregate transmission block in the device.

26. The computer program product of claim 24, wherein the at least one other time period comprises at least one time period later than the first time period.

27. The computer program product of claim 24, wherein the content comprises at least one of video media, audio media, or textual media.

28. The computer program product of claim 24, wherein the set of repair symbols encode the set of high priority blocks and the set of low priority blocks with different priority.

29. The computer program product of claim 24, wherein the computer readable medium further comprises at least one instruction for causing a computer to receive a selection from the user of the device to change a content channel, and at least one instruction for causing a computer to initiate the decoding of at least the set of high priority blocks of an aggregate transmission block in a current time period based on the user selection.

30. The computer program product of claim 24, wherein the transmission to the device is via a set of multiple channels creating time diversity for at least one of the set of high priority blocks, set of low priority blocks, and set of repair symbols.

31. A method of receiving content in a device, comprising:
initiating the delivery of content to the device;
receiving a set of aggregate transmission blocks encoding the content in the device, the set of aggregate transmission blocks being generated by
accessing a set of source blocks representing content to deliver to a device,
decomposing the set of source blocks into a set of high priority blocks and a set of low priority blocks,
performing forward error correction encoding on the set of high priority blocks and the set of low priority blocks to generate a set of repair symbols, and
combining the set of high priority blocks for a first time period with the set of low priority blocks and the set of repair symbols for at least one other time period to generate the set of aggregate transmission blocks for transmission to the device;
receiving a selection from the user of the device to change a content channel; and
initiating the decoding of at least the set of high priority blocks of an aggregate transmission block in a current time period based on the user selection.

32. The method of claim 31, wherein the set of high priority blocks for the first time period are configured to be decoded by the device before receipt of a next aggregate transmission block in the device.

33. The method of claim 31, wherein the at least one other time period comprises at least one time period later than the first time period.

34. The method of claim 31, wherein the content comprises at least one of video media, audio media, or textual media.

35. The method of claim 31, wherein the set of repair symbols encode the set of high priority blocks and the set of low priority blocks with unequal priority.

36. The method of claim 31, wherein the transmission to the device is via a set of multiple channels creating time diversity for at least one of the set of high priority blocks, set of low priority blocks, and set of repair symbols.

37. A device, the device being configured to receive content, comprising:
a first interface to a broadcast system; and
a processor, communicating with the first interface, the processor being configured to
initiate the delivery of content to the device;
receive a set of aggregate transmission blocks encoding the content in the device, the set of aggregate transmission blocks being generated by
accessing a set of source blocks representing content to deliver to a device,
decomposing the set of source blocks into a set of high priority blocks and a set of low priority blocks,
performing forward error correction encoding on the set of high priority blocks and the set of low priority blocks to generate a set of repair symbols, and
combining the set of high priority blocks for a first time period with the set of low priority blocks and the set of repair symbols for at least one other time periods to generate the set of aggregate transmission blocks for transmission to the device;
receive a selection from the user of the device to change a content channel; and
initiate the decoding of at least the set of high priority blocks of an aggregate transmission block in a current time period based on the user selection.

38. The device of claim 37, wherein the set of high priority blocks for the first time period is configured to be decoded by the device before receipt of a next aggregate transmission block in the device.

39. The device of claim 37, wherein the at least one other time period comprises at least one time period later than the first time period.

40. The device of claim 37, wherein the content comprises at least one of video media, audio media, or textual media.

41. The device of claim 37, wherein the set of repair symbols encode the set of high priority blocks and the set of low priority blocks with unequal priority.

42. The device of claim 37, wherein the transmission to the device is via a set of multiple channels creating time diversity for at least one of the set of high priority blocks, set of low priority blocks, and set of repair symbols.

43. A device, the device being configured to receive content, comprising:
first interface means for interfacing to a broadcast system; and
means for processing, communicating with the first interface means, the means for processing being configured to
initiate the delivery of content to the device;
receive a set of aggregate transmission blocks encoding the content in the device, the set of aggregate transmission blocks being generated by
receiving a set of source blocks representing content to deliver to a device,
decomposing the set of source blocks into a set of high priority blocks and a set of low priority blocks,
performing forward error correction encoding on the set of high priority blocks and the set of low priority blocks to generate a set of repair symbols, and
combining the set of high priority blocks for a first time period with the set of low priority blocks and the set of repair symbols for at least one other time period to generate the set of aggregate transmission blocks for transmission to the device;
receive a selection from the user of the device to change a content channel; and
initiate the decoding of at least the set of high priority blocks of an aggregate transmission block in a current time period based on the user selection.

44. The device of claim 43, wherein the set of high priority blocks for the first time period are configured to be decoded by the device before receipt of a next aggregate transmission block in the device.

45. The device of claim 43, wherein the at least one other time period comprises at least one time period later than the first time period.

46. The device of claim 43, wherein the content comprises at least one of video media, audio media, or textual media.

47. The device of claim 43, wherein the set of repair symbols encode the set of high priority blocks and the set of low priority blocks with unequal priority.

48. The device of claim 43, wherein the transmission to the device is via a set of multiple channels creating time diversity for at least one of the set of high priority blocks, set of low priority blocks, and set of repair symbols.

49. A computer program product, comprising:
computer-readable medium comprising:
at least one instruction for causing a computer to initiate the delivery of content to a device;
at least one instruction for causing a computer to receive a set of aggregate transmission blocks encoding the content in the device, the set of aggregate transmission blocks being generated by
accessing a set of source blocks representing content to deliver to a device,
decomposing the set of source blocks into a set of high priority blocks and a set of low priority blocks,
performing forward error correction encoding on the set of high priority blocks and the set of low priority blocks to generate a set of repair symbols, and
combining the set of high priority blocks for a first time period with the set of low priority blocks and the set of repair symbols for at least one other time period to generate the set of aggregate transmission blocks for transmission to the device;
at least one instruction for causing a computer to initiate the reception of a selection from the user of the device to change a content channel; and
at least one instruction for causing a computer to initiate the decoding of at least the set of high priority blocks of an aggregate transmission block in a current time period based on the user selection.

50. The computer program product of claim 49, wherein the set of high priority blocks for the first time period are configured to be decoded by the device before receipt of a next aggregate transmission block in the device.

51. The computer program product of claim 49, wherein the at least one other time period comprises at least one time period later than the first time period.

52. The computer program product of claim 49, wherein the content comprises at least one of video media, audio media, or textual media.

53. The computer program product of claim 49, wherein the set of repair symbols encode the set of high priority blocks and the set of low priority blocks with unequal priority.

54. The computer program product of claim 49, wherein the transmission to the device is via a set of multiple channels creating time diversity for at least one of the set of high priority blocks, set of low priority blocks, and set of repair symbols.

55. A method of encoding data, comprising:
receiving a set of source blocks representing content to deliver to a device;
decomposing the set of source blocks into a set of multiple priority blocks, the set of multiple priority blocks comprising a set of high priority blocks and a set of low priority blocks, the set of low priority blocks being subdivided into a set of multiple levels of lower priority;
performing forward error correction encoding on the set of high priority blocks and the set of low priority blocks to generate a set of repair symbols; and
combining the set of high priority blocks for a first time period with low priority blocks of at least one of the set of multiple levels of lower priority and the set of repair symbols for at least one other time period to generate an aggregate transmission block for transmission to the device.
